(19) United States
(12) Patent Application Publication
(10) Pub. No.: US 2026/0206770 A1
(43) Pub. Date: Jul. 23, 2026

(54) Hydrolysed Protein Uptake Enhancer

(71) Applicant: Croda International Plc, Goole, East Yorkshire (GB)

(72) Inventors: Kathryn KNIGHT, Goole, East Yorkshire (GB); Amie SMITH, Goole, East Yorkshire (GB); James FLAVELL, Goole, East Yorkshire (GB); Patrick COLVER, Goole, East Yorkshire (GB); Robert Michael SAYER, Goole, East Yorkshire (GB)

(73) Assignee: Croda International Plc, Goole, East Yorkshire (GB)

(21) Appl. No.: 19/140,742

(22) PCT Filed: Dec. 19, 2023
(86) PCT No.: PCT/EP2023/086723

§ 371 Date: Jun. 18, 2025

(30) Foreign Application Priority Data
Dec. 19, 2022 (GB) 2219200.9

(51) Int. Cl. A01N 63/50; A01N 25/04; A01N 35/10; A01N 43/54; A01N 43/653; A01N 43/78; A01N 47/22; A01P 3/00; A01P 13/00

(52) U.S. Cl. CPC A01N 63/50; A01N 25/04; A01N 35/10; A01N 43/54; A01N 43/653; A01N 43/78; A01N 47/22; A01P 3/00; A01P 13/00

(57) ABSTRACT

The present invention relates to penetrants for agrochemical formulations, where said formulations comprise at least one penetrant being a hydrolysed protein having molecular weight in the range between 200 to 150,000 Da; and at least one agrochemical active. Preferably, the hydrolysed protein is derived from wheat or potato protein. There is also a method of providing uptake enhancement in said agrochemical formulations using said hydrolysed protein, and methods of treating crops with such formulations. A concentrate is also provided suitable for forming the formulation.

### CROSS-REFERENCE TO RELATED APPLICATIONS

This application is the United States National Phase under 35 U.S.C. 371 of PCT International Patent Application No. PCT/EP2023/086723, filed on Dec. 19, 2023, which claims the benefit of British Patent Application No. 2219200.9, filed on Dec. 19, 2022, the disclosures of which are hereby incorporated by reference herein in their entireties for all purposes.

### FIELD OF THE INVENTION

The present invention relates to penetrants for agrochemical formulations, and a method of providing uptake enhancement in said agrochemical formulations. The present invention also includes methods of treating crops with such formulations.

### BACKGROUND OF THE INVENTION

Adjuvants, and in particular penetration enhancers, are used in agrochemical formulations to aid and enhance the activity and penetration of an agrochemical active ingredient through the leaf cuticle. Adjuvants may provide improved leaf surface wetting, leaf surface penetration of the active, and do not significantly inhibit translocation of the active in the treated plant. In addition, the adjuvant should not produce unwanted phytotoxic effects on the plant.

In particular, certain adjuvants (typically termed penetrants or penetration enhancers for this use) may act to specifically permit or facilitate the uptake of an agrochemical active in to a leaf. These penetrants can markedly reduce the level of the active ingredient required and they can increase the activity or extend the spectrum of effectiveness. These effects can lead to the replacement of high priced or high toxicity active ingredients by lower priced penetrants, thereby delivering better control of the target with a single product.

Recently, there is also a desire to remove fossil-fuel based ingredients from agrochemical formulations, and instead provide more sustainable alternatives.

Therefore, there is a need to find penetrants for uptake enhancement which allow for formation of agrochemical formulations, and overcome the above described problems. Additionally, the present invention seeks to provide penetrants which have desired properties such as deposition characteristics, penetration levels, phytotoxicity etc. compared to existing penetrants. The present invention also seeks to provide the use of agrochemical concentrates and dilute formulations comprising said penetrants.

### SUMMARY OF THE INVENTION

According to a first aspect of the present invention there is provided an agrochemical formulation comprising;
i) at least one penetrant; and
ii) at least one agrochemical active
   wherein the penetrant is a hydrolysed protein, said protein having molecular weight in the range between 200 to 150,000 Da.

According to a second aspect of the present invention there is provided a concentrate formulation suitable for making an agrochemical formulation of the first aspect, said concentrate comprising;
i) at least one penetrant; and
ii) at least one agrochemical active
   wherein the penetrant is a hydrolysed protein, said protein having molecular weight in the range between 200 to 150,000 Da.

According to a third aspect of the present invention there is provided the use of a hydrolysed protein in accordance with the first aspect, as a penetrant in an agrochemical formulation comprising at least one agrochemical active.

According to a fourth aspect of the present invention there is provided a method of treating vegetation to control pests, the method comprising applying a formulation of the first aspect, and/or a diluted concentrate formulation of the second aspect, either to said vegetation or to the immediate environment of said vegetation.

### DETAILED DESCRIPTION OF THE INVENTION

It has been found that a hydrolysed protein, provide for desired penetrant properties when used in an agrochemical formulation.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.

It will be understood that, when describing the number of carbon atoms in a substituent group (e.g. ‘C₁ to C₆ alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

It has surprisingly been found that such a variety of proteins encompassing a range of molecular weights provide good leaf penetration properties.

As used herein, the term ‘penetrant’ or ‘penetration enhancers’ refers to a component which improves the biological action of an active compound, specifically an agrochemical active, without the component itself for its part having a biological action. In particular, the penetrant facilitates the uptake of the active compound into the leaf.

The penetrant can, for example, markedly reduce the level of the active ingredient required, and may therefore increase the activity or extend the spectrum of effectiveness. These effects can lead to the replacement of highly priced or high toxicity active ingredients by lower priced penetrants, delivering better control of the target with a single product.

The term ‘hydrolysed protein’ is used herein to mean proteins which have been subject to hydrolysis. The hydrolysed protein may comprise protein fragments, polypeptides, peptides, amino acids and/or peptones.

Polypeptides, peptides and amino acids may, for example, be produced by acid, alkali and/or enzyme hydrolysis, of native proteins. Enzyme hydrolysed proteins are preferred. In one embodiment, hydrolysed wheat proteins are preferred, in particular produced by enzyme hydrolysis. The hydrolysed protein component may also contain starch, for example hydrolysed wheat protein may contain wheat starch.

The hydrolysed protein may be produced by acid hydrolysis, alkali hydrolysis, and/or enzyme hydrolysis of proteins, preferably naturally occurring proteins or proteins from renewable sources. Without being bound by theory, an advantage of enzyme hydrolysis when compared with acid or alkali hydrolysis is that the enzyme hydrolysis is more selective in the sites on the protein which are hydrolysed, thus producing an improved amino compound for use in making the composition of the invention when compared with acid or alkali hydrolysis. In general, acid hydrolysis may produce the smallest fragments by weight average molecular weight, alkali hydrolysis may produce the largest fragments, while enzyme hydrolysis may produce fragments of intermediate size between acid and alkali hydrolysis.

The size of a fragment in the hydrolysed protein is proportional to the number of amino acid residues in the fragment since the fragments come from the long amino acid chains which make up the unhydrolysed protein. Acid hydrolysis may be disadvantageous due to high temperature and/or pressure requirements.

The amino compound used in making the composition of the invention may be a partially hydrolysed protein. The term ‘partially hydrolysed protein’ means a protein that has not been hydrolysed completely i.e. not been hydrolysed to the extent that only individual amino acids remain in the amino compound.

The amino compound used in making the composition of the invention may be a chemically unmodified hydrolysed protein.

Preferably the composition does not comprise a protein component obtained from an animal protein source. This is advantageous since animal sources can be undesirable for consumers. Preferably the composition comprises no animal derived components. Preferably the composition is suitable for vegan consumers.

The hydrolysed protein present in the seed treatment composition used in the present invention may be derived from either animal or vegetable sources, or by fermentation. Examples of suitable proteins include collagen, chickpea, hemp, elastin, keratin, casein or milk, whey, wheat, wheat starch, potato, soya, and/or silk protein.

The hydrolysed protein may be formed from individual amino acids, or from amino acids comprised within longer peptide chains that are derived from hydrolysed protein. Preferably the hydrolysed protein may be amino acids chain formed from hydrolysing a protein.

It will be understood that the protein component is a mixture of amino acids and short protein chains, small peptides, or large molecular weight proteins.

The penetrant may be partially hydrolysed protein obtained from a potato source. The potato protein source may be a potato protein concentrate and/or isolate. An aqueous dispersion of the potato protein concentrate and/or isolate may be made as a first step and the protein may be hydrolysed as a second step. A difference between the potato protein source and the partially hydrolysed protein may be that the partially hydrolysed protein is more soluble in water at a reference temperature (e.g. room temperature) than the potato protein source.

The partially hydrolysed potato protein may be produced by acid, alkali or enzyme hydrolysis. Where enzyme hydrolysis is used, one or more enzymes may be used. The enzyme is preferably not animal derived. Preferably the enzyme is from a micro-organism source. The enzyme(s) may comprise a carbohydrase and/or a protease.

The hydrolysis may be performed to the extent required to achieve the desired weight average molecular weight of the hydrolysed potato protein. The extent of hydrolysis may be varied by varying the temperature, acid/alkali/enzyme used, and time taken. The resulting hydrolysed protein may be filtered and/or treated to remove undesired material. For example, the hydrolysed protein may be treated to remove any chloride ions present if acid hydrolysis is used.

The weight average molecular weight (Mw) of the hydrolysed potato protein of the first component may be at least 200 Daltons (Da), preferably at least 300 Da, more preferably at least 400 Da, particularly at least 500 Da. The weight average molecular weight may be at most 150,000 Da, preferably at most 120,000 Da, more preferably at most 110,000 Da, particularly at most 100,000 Da.

The molecular weight may be measured by size exclusion chromatography such as size-exclusion HPLC (SE-HPLC) as described in the Test Methods below.

The molecular weight (weight average) of the wheat protein component starting material (prior to hydrolysis) may vary over a wide range, such as for example in the range from 100 to 500,000 Daltons. Molecular weight average will be understood to be a measurement of the value across the whole range of amino acid comprising compounds in the seed coating composition.

The molecular weight (weight average) of the hydrolysed wheat protein may vary over a wide range, such as for example in the range from 40 Da to 20,000 Da, preferably 60 Da to 10,000 Da, more preferably 80 Da to 5,000 Da. In a further embodiment, the hydrolysed protein may have an average molecular weight in the range from 40 Da to 2,000 Da, preferably 60 Da to 1,000 Da, in particular about 80 Da to 500 Da.

The molecular weight may be measured by size exclusion chromatography such as size-exclusion HPLC (SE-HPLC) as described in the Test Methods below.

In particular, where wheat protein is preferred, the individual hydrolysed protein segments may comprise on average in the range from 1.5 to 200, preferably 5 to 100, more preferably 8 to 50, particularly 10 to 25 amino acids. In a further embodiment, the individual hydrolysed protein segments may comprise on average in the range from 1 to 10, preferably 1 to 5, more preferably 1 to 3, particularly 1 to 2 amino acids.

The hydrolysis performed will be to the extent required to achieve the desired molecular weight and chain length of the hydrolysed wheat protein. The degree of hydrolysis may be varied by varying the temperature, pH, concentration and type of enzyme used, and time taken.

The hydrolysed wheat protein may be filtered and treated to remove undesired material.

It is preferred that the hydrolysed protein component is capable of forming a solution in water.

The penetrant may be partially hydrolysed protein obtained from a hemp source. The hemp protein source may be a hemp protein concentrate and/or isolate. An aqueous dispersion of the hemp protein concentrate and/or isolate may be made as a first step and the protein may be hydrolysed as a second step. A difference between the hemp protein source and the partially hydrolysed hemp protein may be that the partially hydrolysed protein is more soluble in water at a reference temperature (e.g. room temperature) than the hemp protein source.

The partially hydrolysed hemp protein may be produced by acid, alkali or enzyme hydrolysis. Alkali hydrolysis is preferred. The hydrolysis may be performed to the extent required to achieve the desired weight average molecular weight of the hydrolysed protein. The extent of hydrolysis may be varied by varying the temperature, acid/alkali/enzyme used, and time taken. The resulting hydrolysed protein may be filtered and/or treated to remove undesired material. For example, the hydrolysed protein may be membrane washed to remove any salt present.

The molecular weight (weight average) of the hydrolysed protein may vary over a wide range, such as for example in the range from 1,000 Da to 500,000 Da, preferably 5,000 Da to 200,000 Da, more preferably 10,000 Da to 150,000 Da. In one embodiment, the hydrolysed protein may have an average molecular weight in the range from 15,000 Da to 100,000 Da, preferably 20,000 Da to 80,000 Da, in particular 25,000 Da to 75,000 Da, for example about 70,000 Da.

The molecular weight may be measured by size exclusion chromatography such as size-exclusion HPLC (SE-HPLC) as described in the Test Methods below.

The penetrant may be partially hydrolysed protein obtained from a silk source. The silk protein source may be a silk protein concentrate and/or isolate, preferably from silk noils. An aqueous dispersion of the silk protein concentrate and/or isolate may be made as a first step and the protein may be hydrolysed as a second step. A difference between the silk protein source and the partially hydrolysed protein may be that the partially hydrolysed protein is more soluble in water at a reference temperature (e.g. room temperature) than the silk protein source.

The partially hydrolysed protein may be produced by acid, alkali or enzyme hydrolysis. Alkali hydrolysis is preferred. The hydrolysis may be performed to the extent required to achieve the desired weight average molecular weight of the hydrolysed protein. The extent of hydrolysis may be varied by varying the temperature, acid/alkali/enzyme used, and time taken. The resulting hydrolysed protein may be filtered and/or treated to remove undesired material. For example, the hydrolysed protein may be membrane washed or passed through an ion exchange resin to remove any salt present.

The molecular weight (weight average) of the hydrolysed protein may vary over a wide range, such as for example in the range from 50 Da to 50,000 Da, preferably 100 Da to 5,000 Da, more preferably 150 Da to 1,500 Da. In one embodiment, the hydrolysed protein may have an average molecular weight in the range from 200 Da to 1,000 Da, preferably 300 Da to 750 Da, in particular 400 Da to 600 Da, for example about 450 Da.

The molecular weight may be measured by size exclusion chromatography such as size-exclusion HPLC (SE-HPLC) as described in the Test Methods below.

The penetrant may be partially hydrolysed protein obtained from a milk source. The milk protein source may be a milk protein concentrate and/or isolate for example, sodium caseinate. An aqueous dispersion of the milk protein concentrate and/or isolate may be made as a first step and the protein may be hydrolysed as a second step. A difference between the milk protein source and the partially hydrolysed protein may be that the partially hydrolysed protein is more soluble in water at a reference temperature (e.g. room temperature) than the milk protein source.

The partially hydrolysed milk protein may be produced by acid, alkali or enzyme hydrolysis. Enzyme hydrolysis is preferred. One or more enzymes may be used and may be from an animal or micro-organism source. The hydrolysis may be performed to the extent required to achieve the desired weight average molecular weight of the hydrolysed protein. The extent of hydrolysis may be varied by varying the temperature, acid/alkali/enzyme used, and time taken. The resulting hydrolysed protein may be filtered and/or treated to remove undesired material. For example, the hydrolysed protein may be treated with activated carbon to reduce odour and colour.

The weight average molecular weight (Mw) of the hydrolysed protein of the first component may be at least 200 Daltons (Da), preferably at least 300 Da, more preferably at least 400 Da, particularly at least 500 Da. The weight average molecular weight may be at most 100,000 Da, preferably at most 50,000 Da, more preferably at most 10,000 Da, particularly at most 5,000 Da, especially at most 2,500 Da.

The molecular weight may be measured by size exclusion chromatography such as size-exclusion HPLC (SE-HPLC) as described in the Test Methods below.

Chemically modified proteins and/or hydrolysed proteins may also be employed, for example where the protein has been covalently reacted with a functional group, e.g. a silicone, vinyl polymer, or anhydrides such as carboxylic anhydrides or alkenyl succinic anhydride. The or each hydrolysed protein may independently be further chemically modified, for example where the protein has been covalently reacted with said functional group.

The alkenyl succinic anhydride may be selected from tetrapropenyl succinic anhydride, dodecenyl succinic anhydride, octenyl succinic anhydride, nonenyl succinic anhydride, or iso-octadecenylsuccinic anhydride. Preferably, the alkenyl succinic anhydride is octenyl succinic anhydride

Preferably the hydrolysed protein may be chemically unmodified hydrolysed protein.

One or more of the hydrolysed proteins may be a chemically unmodified hydrolysed protein. The term ‘chemically unmodified hydrolysed protein’ means a protein that has not been further chemically modified (or reacted) other than by hydrolysis.

Hydrolysed polymers may be modified by more than one functional group. Alternatively, the bulk hydrolysed protein may comprise a mixture of proteins modified by different functional groups.

In the embodiment where the hydrolysed protein is modified, modification may comprise reacting at least 20% of the protein with a functional group, preferably more than 30%, more preferably more than 40%.

An example of chemical modification may be modification with itaconic anhydride. This may serve to change the charge of the protein which would have the effect of increasing the solubility of the protein. Additionally, itaconic anhydride is also biobased.

The composition can comprise an itaconic modified amino compound, wherein the itaconic modified amino compound, wherein the amount of itaconic anhydride used is calculated to react with 1 mol % to 100 mol % of the free amino groups of the amino compound.

Preferably the amount of itaconic anhydride used is calculated to react with more than 70 mol % of the free amino groups in the amino compound. More preferably the amount of itaconic anhydride used is calculated to react with more than 80 mol % of the free amino groups in the amino compound. Most preferably, amount of itaconic anhydride used is calculated to theoretically react with more than 95 mol % of the free amino groups in the amino compound, although it would be expected that in the range of 70-85 mol % of free amino groups would actually react.

Where the hydrolysed protein is chemically modified, the ratio of reactants may influence the properties of the composition of the invention. Preferably at least 2 mol %, more preferably at least 5 mol %, more preferably at least 10 mol %, more preferably at least 15 mol %, more preferably at least 20 mol % of the free amino groups in the amino compound are reacted with the itaconic anhydride in the itaconic modified amino compound. Preferably at most 99 mol %, more preferably at most 98 mol %, more preferably at most 95 mol %, more preferably at most 90 mol % more preferably at most 80 mol % of the free amino groups in the amino compound are reacted with the itaconic anhydride in the itaconic modified amino compound.

Preferably the calculation is by Formol titre as described herein.

Preferably the amino compound is obtained from a renewable source. Preferably the amino compound is not obtained from an animal protein source. This is advantageous since animal sources can be undesirable for consumers. Preferably the composition comprises no animal-derived components. Preferably the composition comprises no petrochemical-derived components.

Preferably the carbon-containing parts of the composition are at least 40% biobased according to OECD 301F and 302B on the basis of the total weight of the carbon-containing parts of the composition, more preferably at least 50%, particularly at least 60% biobased.

Preferably the amino compound comprises hydrolysed protein, more preferably consists essentially of hydrolysed protein, more preferably is hydrolysed protein. The hydrolysed protein may be produced by acid, alkali or enzyme hydrolysis. Enzyme hydrolysis is preferred. One or more enzymes may be used. The enzyme is preferably not animal derived. Preferably the enzyme is from a micro-organism source. The enzyme(s) may comprise a carbohydrase and/or a protease. Preferably the enzyme comprises a protease. The hydrolysis may be performed to the extent required to achieve the desired weight average molecular weight of the hydrolysed protein. The extent of hydrolysis may be varied by varying the temperature, acid/alkali/enzyme used, and time taken. The resulting hydrolysed protein may be filtered and/or treated to remove undesired material. For example the hydrolysed protein may be treated to remove any chloride ions present if acid hydrolysis is used.

Suitable agrochemical actives for use in the formulations according to the invention are all agrochemically active compounds. It is envisaged that the penetrant of the present invention would have broad applicability to all types of agrochemical actives.

Agrochemical actives refer to biocides which, in the context of the present invention, are plant protection agents, more particular chemical substances capable of killing different forms of living organisms used in fields such as medicine, agriculture, forestry, and mosquito control. Also counted under the group of biocides are so-called plant growth regulators.

Biocides for use in agrochemical formulations of the present invention are typically divided into two sub-groups:
pesticides, including fungicides, herbicides, insecticides, algicides, moluscicides, miticides and rodenticides, and
antimicrobials, including germicides, antibiotics, antibacterials, antivirals, antifungals, antiprotozoals and antiparasites.

In particular, biocides selected from insecticides, fungicides, or herbicides may be particularly preferred.

The term ‘pesticide’ will be understood to refer to any substance or mixture of substances intended for preventing, destroying, repelling, or mitigating any pest. A pesticide may be a chemical substance or biological agent (such as a virus or bacteria) used against pests including insects, plant pathogens, weeds, mollusks, birds, mammals, fish, nematodes (roundworms) and microbes that compete with humans for food, destroy property, spread disease or are a nuisance. In the following examples, pesticides suitable for the agrochemical compositions according to the present invention are given.

A fungicide is a chemical control of fungi. Fungicides are chemical compounds used to prevent the spread of fungi in gardens and crops. Fungicides are also used to fight fungal infections. Fungicides can either be contact or systemic. A contact fungicide kills fungi when sprayed on its surface. A systemic fungicide has to be absorbed by the fungus before the fungus dies.

Examples for suitable fungicides, according to the present invention, encompass the following species: (3-ethoxypropyl) mercury bromide, 2-methoxyethylmercury chloride, 2-phenylphenol, 8-hydroxyquinoline sulphate, 8-phenylmercuri oxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulphide, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, blasticidin-S, Bordeaux mixture, boscalid, bridged diphenyl fungicides, bromuconazole, bupirimate, Burgundy mixture, buthiobate, butylamine, calcium polysulphide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper (II) acetate, copper (II) carbonate, basic, copper fungicides, copper hydroxide, copper naphthenate, copper oleate, copper oxychloride, copper (II) sulphate, copper sulphate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, dinitrophenol fungicides, dinobuton, dinocap, dinocton, dinopenton, dinosulphon, dinoterbon, diphenylamine, dipyrithione, disulphiram, ditalimfos, dithianon, dithiocarbamate fungicides, DNOC, dodemorph, dodicin, dodine, DONATODINE, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulph, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, fluopicolide, fluoroimide, fluotrimazole, fluoxastrobin, fluquinconazole, flusilazole, flusulphamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, lime sulphur, mancopper, mancozeb, maneb, mebenil, mecarbinzid, mepanipyrim, mepronil, mercuric chloride, mercuric oxide, mercurous chloride, mercury fungicides, metalaxyl, metalaxyl-M, metam, metazoxolon, metconazole, methasulphocarb, methfuroxam, methyl bromide, methyl isothiocyanate, methylmercury benzoate, methylmercury dicyandiamide, methylmercury pentachlorophenoxide, metiram, metominostrobin, metrafenone, metsulphovax, milneb, morpholine fungicides, myclobutanil, myclozolin, N-(ethylmercury)-p-toluenesulphonanilide, nabam, natamycin, nitrostyrene, nitrothal-isopropyl, nuarimol, OCH, octhilinone, ofurace, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulphamide fungicides, phosdiphen, phthalide, phthalimide fungicides, picoxystrobin, piperalin, polycarbamate, polymeric dithiocarbamate fungicides, polyoxins, polyoxorim, polysulphide fungicides, potassium azide, potassium polysulphide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfiir, pyrrole fungicides, quinacetol, quinazamid, quinconazole, quinoline fungicides, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulphide, spiroxamine, streptomycin, strobilurin fungicides, sulphonanilide fungicides, sulphur, sultropen, TCMTB, tebuconazole, tecloftalam, tecnazene, tecoram, tetraconazole, thiabendazole, thiadifluor, thiazole fungicides, thicyofen, thifluzamide, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, trifloxystrobin, triflumizole, triforine, triticonazole, unclassified fungicides, undecylenic acid, uniconazole, urea fungicides, validamycin, valinamide fungicides, vinclozolin, zarilamid, zinc naphthenate, zineb, ziram, zoxamide, and mixtures thereof.

An herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Suitable herbicides may be selected from the group comprising: aryloxycarboxylic acid e.g. MCPA, aryloxyphenoxypropionates e.g. clodinafop, cyclohexanedione oximes e.g. sethoxydim, dinitroanilines e.g. trifluralin, diphenyl ethers e.g. oxyfluorfen, hydroxybenzonitriles e.g. bromoxynil, sulphonylureas e.g. nicosulphuron, triazolopyrimidines e.g. penoxsulam, triketiones e.g. mesotriones, or ureas e.g. diuron, phenmedipham or desmedipham.

An insecticide is a pesticide used against insects in all developmental forms, and include ovicides and larvicides used against the eggs and larvae of insects. Insecticides are used in agriculture, medicine, industry and the household.

Suitable insecticides may include those selected from:
Chlorinated insecticides such as, for example, Camphechlor, DDT, Hexachlorocyclohexane, gamma-Hexachlorocyclohexane, Methoxychlor, Pentachlorophenol, TDE, Aldrin, Chlordane, Chlordecone, Dieldrin, Endosulphan, Endrin, Heptachlor, Mirex and their mixtures;
Organophosphorous compounds such as, for example, Acephate, Azinphos-methyl, Bensulide, Chlorethoxyfos, Chlorpyrifos, Chlorpyriphos-methyl, Diazinon, Dichlorvos (DDVP), Dicrotophos, Dimethoate, Disulphoton, Ethoprop, Fenamiphos, Fenitrothion, Fenthion, Fosthiazate, Malathion, Methamidophos, Methidathion, Methyl-parathion, Mevinphos, Naled, Omethoate, Oxydemeton-methyl, Parathion, Phorate, Phosalone, Phosmet, Phostebupirim, Pirimiphos-methyl, Profenofos, Terbufos, Tetrachlorvinphos, Tribufos, Trichlorfon and their mixture;
Carbamates such as, for example, Aldicarb, Carbofuran, Carbaryl, Methomyl, 2-(l-Methylpropyl)phenyl methylcarbamate and their mixtures;
Pyrethroids such as, for example, Allethrin, Bifenthrin, Deltamethrin, Permethrin, Resmethrin, Sumithrin, Tetramethrin, Tralomethrin, Transfluthrin and their mixtures;
Plant toxin derived compounds such as, for example, Derris (rotenone), Pyrethrum, Neem (Azadirachtin), Nicotine, Caffeine and their mixtures.
Neonicotinoids such as imidacloprid.
Abamectin e.g. emamactin
Oxadiazines such as indoxacarb
Anthranilic diamides such as rynaxypyr

Rodenticides are a category of pest control chemicals intended to kill rodents. Suitable rodenticides may include anticoagulants, metal phosphides, phosphides, and calciferols (vitamins D), and derivatives thereof.

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such as moths, slugs and snails. These substances include metaldehyde, methiocarb and aluminium sulphate. A nematicide is a type of chemical pesticide used to kill parasitic nematodes (a phylum of worm).

In the following examples, antimicrobials suitable for agrochemical compositions according to the present invention are given.

Bactericidal disinfectants may include those selected from active chlorines, active oxygen, iodine, concentrated alcohols, phenolic substances, cationic surfactants, strong oxidisers, heavy metals and their salts, and concentrated strong acids and alkalis between pH of from 1 to 13.

Suitable antiseptics (i.e., germicide agents that can be used on human or animal body, skin, mucoses, wounds and the like) may include diluted chlorine preparations, iodine preparations, peroxides, alcohols with or without antiseptic additives, weak organic acids, phenolic compounds, and cation-active compounds.

Preferred actives are those with systemic or partially systemic mode of action.

Particular preference is given to active compounds from the classes of the azole fungicides (azaconazole, bitertanol, bromuconazole, cyproconazole, diclobutrazole, difenoconazole, diniconazole, diniconazole-M, epoxiconazole, etaconazole, fenarimol, fenbuconazole, fluquinconazole, flurprimidol, flusilazole, flutriafol, furconazole, furconazole-cis, hexaconazole, imazalil, imazalil sulphate, imibenconazole, ipconazole, metconazole, myclobutanil, nuarimol, oxpoconazole, paclobutrazole, penconazole, pefurazoate, prochloraz, propiconazole, prothioconazole, pyrifenox, simeconazole, tebuconazole, tetraconazole, triadimefon, triadimenol, triflumizole, triforin, triticonazole, uniconazole, voriconazole, viniconazole), strobilurin fungicides (azoxystrobin, dimoxystrobin, fluoxastrobin, kresoxim-methyl, metominostrobin, orysastrobin, picoxystrobin, pyraclostrobin, trifloxystrobin), the SDH fungicides, the chloronicotinyl insecticides (clothianidin, dinotefuran, imidacloprid, thiamethoxam, nitenpyram, nithiazin, acetamiprid, nitenpyram, thiacloprid), the insecticidal ketoenols (spirodiclofen, spiromesifen, spirotetramate), fiproles (fiprole, ethiprole) and butenolides, and also pymetrozine, fluopicolid, N-(3′,4′-dichloro-5-fluoro-1,1′-biphenyl-2-yl)-3-(difluoromethyl)-1-methyl-1H-pyrazole-4-carboxamide and N-{2-[3-chloro-5-(trifluoromethyl)-2-pyridinyl]ethyl}-2-(trifluoromethyl)benzamide. Particular preference is also given to herbicides, in particular sulphonylureas, triketones and herbicidal ketoenols, and also safeners.

Very particularly preferred as active compounds are;
the fungicides tebuconazole, prothioconazole, N-(3′,4′-dichloro-5-fluoro-1,1′-biphenyl-2-yl)-3-(difluoromethyl)-1-methyl-1H-pyrazole-4-carboxamide (known from WO 03/070705), N-{2-[3-chloro-5-(trifluoromethyl)-2-pyridinyl]ethyl}-2-(trifluoromethyl)benzamide (known from WO 04/16088), trifloxystrobin, azoxystrobin, and fluopicolid;
the insecticides imidacloprid, thiamethoxam, clothianidin, thiacloprid, spirotetramate, fipronil, ethiprol and
the herbicides thiencarbazone, sulcotrione, mesotrione, tembotrione, pyrasulphotole, iodosulphuron, phenmedipham, mesosulphuron and forarnsulphuron.

### 1

Agrochemically active compounds, including insecticides and fungicides, require a formulation which allows the active compounds to be taken up by the plant/the target organisms.

The penetrant may be combined with other components in order to form an agrochemical formulation comprising at least one agrochemical active.

Accordingly, agrochemical active compounds may be formulated as an emulsifiable concentrate (EC), emulsion concentrate (EW), suspension concentrate (SC), soluble liquid (SL), as an oil-based suspension concentrate (OD), and/or suspoemulsions (SE).

In an EC formulation and in an SL formulation, the active compound may be present in dissolved form, whereas in an OD or SC formulation the active compound may be present as a solid.

It is envisaged that the penetrant of the present invention will particularly find use in a SC formulation. Typically, said SC formulation may be in the form of an aqueous solution with the penetrant dissolved therein, and an insoluble solid agrochemical active dispersed in said solution.

The term ‘agrochemical formulation’ as used herein refers to compositions including an active agrochemical, and is intended to include all forms of compositions, including concentrates and spray formulations. If not specifically stated, the agrochemical formulation of the present invention may be in the form of a concentrate, a diluted concentrate, or a sprayable formulation.

The penetrant of the present invention may be combined with other components in order to form an agrochemical formulation comprising at least one agrochemical active.

The penetrant of the present invention, when used in an agrochemical formulation, provides desired effects, in particular for good leaf penetration, low phytotoxicity, and good deposition.

The formulations of the present invention may be of any type, but preferably are water based formulations. In the concentrate form these are generally used to disperse active ingredients.

These aqueous agrochemical concentrates are agrochemical compositions designed to be diluted with water (or a water-based liquid) to form the corresponding spray formulations.

Spray formulations are aqueous agrochemical formulations including all the components which it is desired to apply to the plants or their environment. Spray formulations can be made up by simple dilution of concentrates containing desired components (other than water).

A penetrant may therefore be incorporated into the formulation of the agrochemical active compound (in-can formulation) or be added after dilution of the concentrated formulation of the spray liquor (tank-mix). To avoid dosage errors and to improve user safety during application of agrochemical products, it is advantageous to incorporate the penetrants into the formulation. This also avoids the unnecessary use of additional packaging material for the tank-mix products.

According to the needs of the customer, concentrates thus formed may comprise typically up to 95 wt. % agrochemical actives. Said concentrates may be diluted for use resulting in a dilute composition having an agrochemical active concentration of about 0.5 wt. % to about 1 wt. %. In said dilute composition (for example, a spray formulation, where a spray application rate may be from 10 to 500 l·ha⁻¹) the agrochemical active concentration may be in the range from about 0.001 wt. % to about 1 wt. % of the total formulation as sprayed.

The penetrant of the present invention will typically be present in the concentrate at from 1 wt. % to 20 wt. %. Preferably, from 5 wt. % to 15 wt. %. More preferably, from 8 wt. % to 12 wt. %.

When concentrates (solid or liquid) are used as the source of active agrochemical and/or penetrant, the concentrates will typically be diluted to form the spray formulations. The dilution may be with from 1 to 10,000, particularly 10 to 1,000, times the total weight of the concentrate of water to form the spray formulation.

Where the agrochemical active is present in the aqueous end use formulation as solid particles, most usually it will be present as particles mainly of active agrochemical. However, if desired, the active agrochemical can be supported on a solid carrier e.g. silica or diatomaceous earth, which can be solid support, filler or diluent material as mentioned above.

Where the dispersed phase is a non-aqueous liquid, it will typically be an oil. The oil may be or include a mineral oil, including aliphatic (paraffin) mineral oils and aromatic mineral or synthetic oils, such as those sold under the trade name Solvesso; an optionally hydrogenated vegetable oil, such as an optionally hydrogenated cotton seed oil, linseed oil, mustard oil, neem oil, niger seed oil, oiticica oil, olive oil, palm oil, palm kernel oil, peanut oil, perilla oil, poppy seed oil, rape seed oil, safflower oil, sesame oil, or soybean oil; an ester oil (a synthetic ester oil), especially a C16 ester of a C8 to C22 fatty acid, especially a C12 to C18 fatty acid, or a mixture of esters, such as methyl laurate, 2-ethylhexyl laurate, heptadecanoate, heptadecenoate, heptadecadienoate, stearate or oleate, and in particular methyl laurate and oleate; N-methylpyrrolidone; or an isoparaffin; or a mixture of such oils.

The spray formulations will typically have a pH within the range from moderately acidic (e.g. about 3) to moderately alkaline (e.g. about 10), and particular near neutral (e.g. about 5 to 8). More concentrated formulations will have similar degrees of acidity/alkalinity, but as they may be largely non-aqueous, pH is not necessarily an appropriate measure of this.

The agrochemical formulation may include solvents (other than water) such as monopropylene glycol, oils which can be vegetable or mineral oils such as spray oils (oils included in spray formulations as non-surfactant adjuvants), associated with the penetrant. Such solvents may be included as a solvent for the penetrant and/or as a humectant e.g. especially propylene glycol. When used such solvents will typically be included in an amount of from 5 wt. % to 500 wt. %, desirably 10 wt. % to 100 wt. %, by weight of the penetrant. Such combinations can also include salts such as ammonium chloride and/or sodium benzoate and or urea especially as gel inhibition aids.

The formulation may also comprise additional component selected from pigments, dyes, micronutrients, agrochemical actives, bulking agents, and combinations thereof.

The agrochemical formulation may include solvents (other than water) such as monopropylene glycol, oils which can be vegetable or mineral oils such as spray oils (oils included in spray formulations as non-surfactant adjuvants), associated with the first and co-adjuvants.

Such solvents may be included as a solvent for the adjuvant, and/or as a humectant, e.g. especially propylene glycol. When used such solvents will typically be included in an amount of from 5 wt. % to 500 wt. %, desirably 10 wt. % to 100 wt. %, by weight of the adjuvant. Such combinations can also include salts such as ammonium chloride and/or sodium benzoate, and/or urea especially as gel inhibition aids.

The agrochemical formulation may also include other components as desired. These other components may be selected from those including:
binders, particularly binders which are readily water soluble to give low viscosity solutions at high binder concentrations, such as polyvinylpyrrolidone; polyvinyl alcohol; carboxymethyl cellulose; gum arabic; sugars e.g. sucrose or sorbitol; starch; ethylene-vinyl acetate copolymers, sucrose and alginates,
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, e.g. polysiloxane antifoam agents, typically in amounts of 0.005 wt. % to 10 wt. % of the formulation;
viscosity modifiers such as commercially available water soluble or miscible gums, e.g. xanthan gums, and/or cellulosics, e.g. carboxy-methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The agrochemical formulation according to the present invention may also contain components, such as surfactant materials which form part of the emulsifier system. Said surfactants may include surfactant dispersants.

### 2

The formulation may comprise at least one nutrient. Nutrients refer to chemical elements and compounds which are desired or necessary to promote or improve plant growth.

Nutrients generally are described as macronutrients or micronutrients. Suitable nutrients for use in the concentrates according to the invention are micronutrient compounds, preferably those which are solid at room temperature or are partially soluble.

Micronutrients typically refer to trace metals or trace elements, and are often applied in lower doses. Suitable micronutrients include trace elements selected from zinc, boron, chlorine, copper, iron, molybdenum, and manganese. It is envisaged that the penetrant of the present invention would have broad applicability to all types of micronutrients.

The micronutrients may be in a soluble form or included as insoluble solids, and may in the form of salts or chelates. Preferably, the micronutrient is in the form of a carbonate or oxide.

Preferably, the micronutrient may be selected from zinc, calcium, molybdenum or manganese, or magnesium. Particularly preferred micronutrients for use with the present invention may be selected from zinc oxide, manganese carbonate, manganese oxide, or calcium carbonate.

The amount of micronutrient in the concentrate is typically from 5 wt. % to 40 wt. %, more usually, 10 wt. % to 35 wt. %, particularly 15 wt. % to 30, % by weight based on the total concentrate.

Typically, as mixed into formulations during make up the average particle size of solid agrochemicals is from 50 μm to 100 μm, but formulations are typically wet milled after mixing to reduce the average particle size to from 1 μm to 10 μm, more preferably from 1 μm to 5 μm.

The formulations of the present invention may also comprise at least one macronutrient. Macronutrients typically refer to those comprising nitrogen, phosphorus, and potassium, and include fertilisers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myoinositol, glycine, and combinations thereof.

The invention further includes a method of treating plants using formulations of the first aspect.

Accordingly the invention further includes methods of use including:
a method of killing or inhibiting vegetation by applying to the vegetation, or the immediate environment of the vegetation e.g. the soil around the vegetation, a spray formulation including at least one agrochemical and the penetrant of the first aspect; and/or
a method of killing or inhibiting pests of plants by applying to the plants or the immediate environment of the plants e.g. the soil around the plants, a spray formulations including at least one agrochemical which is one or more pesticides, for example insecticides, fungicides or acaricides, and the penetrant of the first aspect.

Preferably, the penetrant of the present invention may find use as either the sole component or principal penetrant functioning agent when formulated directly into pesticide concentrates.

The penetrant of the present invention dilute more readily in agricultural concentrates and develop lower fluid viscosities in aqueous systems, either in the concentrate or upon dilution into water prior to spraying. This behaviour provides improved ease of use in both manufacturing and upon dilution of products containing them, especially in colder waters.

Reduction of foam stability is also observed which reduces the need for foam control agents. The penetrant of the present invention may be added to agrochemical formulations without undesirable thickening or destabilisation.

The penetrant may also have general adjuvancy properties. Said dual function may allow for improved formulation space.

All of the features described herein may be combined with any of the above aspects, in any combination.

In order that the present invention may be more readily understood, reference will now be made, by way of example, to the following description.

### 3. Examples

It will be understood that all tests and physical properties listed have been determined at atmospheric pressure and room temperature (i.e. 25° C.), unless otherwise stated herein, or unless otherwise stated in the referenced test methods and procedures.

The following test methods were used to determine performance of the adjuvant compositions.
Weight average molecular weight—was determined by Size-Exclusion High Performance Liquid Chromatography (SE-HPLC). The HPLC apparatus using a Supadex 30 column was used for molecular weights of less than 10,000 Da, and the GMPWXL method was used for larger molecular weights of 10,000 Da or more.

HPLC apparatus and settings

| Spectrometer | Agilent 1200 series HPLC | |
|---|---|---|
| Detector | UV @ 220 nm | |
| Columns | Superdex 30 Increase | |
| Solvent | 0.1% TFA, 0.1M Na₂SO₄, 22% MeCN | |
| Concentration of test substance | 0.02 | g/ml |
| Column temperature | 25° | C. |
| Flow rate | 0.8 | ml/min |
| Injection Volume | 10 | μL |
| Analysis time | 45 | minutes |

| | |
|---|---|
| Method control and integration | Agilent OpenLab software |
| Method Type | Peak area integration |
| Calibration | The following standards (8 points) are |
| | used to calibrate the curve using |
| | polynomial 3: 12,384 (Da) Cytochrome |
| | C, 1,423 Bacitracin, 433 Arg-Gly-Asp- |
| | Ser, 146 Glutamine, 3496 Insulin Chain |
| | B, 1355 Vitamin B12, 189 (Gly)3, 75 |
| | Glycine |

TFA—trifluoracetic acid

| Spectrometer | Agilent 1200 series HPLC | |
|---|---|---|
| Detector | UV @ 220 nm | |
| Columns | GMPWXL | |
| Solvent | 50 mM KH₂PO₄, 65 mM K₂HPO₄, 100 mM | |
| | NaCl, 20% MeCN, adjusted to pH 7.0 | |
| Concentration of test | ~0.02 | g/ml |
| substance | | |
| Column temperature | 40° | C. |
| Flow rate | 0.6 | ml/min |
| Injection Volume | 5 | μL |
| Analysis time | 45 | minutes |

| | |
|---|---|
| Method control and | Agilent OpenLab software |
| integration | |
| Method Type | Peak area integration |
| Calibration | Sodium styrene sulphonate standards with |
| | a polynomial 3 fit: Vial 1 666,000; 63,900; |
| | 6,520, Vial 2 282,000; 29,100; 3,610 |
| | Vial 3 148,000; 14,900; 246, |

### Synthesis Examples

The following materials were made.

### Itaconic Modified Hydrolysed Potato Amino Acid (MW 550 Da, Activity 18.78%) (P1)

To a 5 l jacketed vessel, potato protein isolate powder (1,000 g) was added to a solution of HCl (2,500 g). The vessel was heated to 125° C. and the protein was allowed to hydrolyse for 12 hours. The vessel was cooled to room temperature and adjusted to pH 4.0 using NaOH. Any undissolved material was removed via filtration and the protein solution was purified with activated carbon. The resulting solution was adjusted to pH 10.2 using NaOH and evaporated by rotor evaporator to concentrate.

To the above hydrolysed protein solution (2,640 g), itaconic anhydride (265 g) was added over 1 hour. The pH was maintained between 9.9 and 10.5 using NaOH. The pH was controlled for a further 2 hours with stirring before HCl was added to reduce the pH to 4.4. The solution was washed used a spiral NF membrane to remove salt before it was preserved.

### OSA Modified Hydrolysed Potato Amino Acid (MW 461 Da, Activity 24.77%) (P2)

To a 21 jacketed vessel, potato protein isolate powder (500 g) was added to a solution of H₂SO₄ (1,275 g). The vessel was heated to 125° C. and the protein was allowed to hydrolyse for 14 hours. The vessel was cooled to room temperature and adjusted to pH 4.5 using Ca(OH)₂. Any undissolved material was removed via filtration and the protein solution was purified with activated carbon. The resulting solution was evaporated by rotor evaporator to concentrate.

The above hydrolysed protein solution (534 g) was adjusted to pH 10.3 using NaOH and heated to 40° C. N-octenyl succinic anhydride (94 g) was added over 2 hours. The pH was maintained between 9.9 and 10.4 using NaOH. The pH was controlled for a further 2 hours with stirring before HCl was added to reduce the pH to 3.0 which caused to product to precipitate. The aqueous layer was removed, and the precipitate was dissolved by adding water and NaOH to raise the pH to 4.8. The final product was preserved to prevent microbial growth.

### Itaconic Acid Modified Hydrolysed Wheat Amino Acid (MW 721 Da, Activity 23.08%) (P3)

Wheat protein isolate (80 g) was stirred into water (720 g) and heated to 50° C. The pH was raised to pH 9.5. Alcalase (1.2 g) was added and allowed to react for 1 hour. Neutrase was added (1.2 g) followed by Flavourzyme (1.2 g). The reaction was allowed to proceed at temperature for 18 hours before HCl was added to reduce the pH to 4.0. The slurry was heated to 85° C. for 15 minutes to denature the enzymes and then filtered to remove any solids. The protein solution was purified with activated carbon then adjusted to pH 10.2 using NaOH and evaporated to the desired concentration.

To the above hydrolysed protein solution (150 g), itaconic anhydride (3 g) was added over 20 minutes. The pH was maintained between 9.8 and 10.4 using NaOH. The pH was controlled for a further 1 hour with stirring before HCl was added to reduce the pH to 4.5. The final product was preserved to prevent microbial growth.

### Hydrolysed Milk Protein (MW 1,400 Da, Activity 20.1%) (P4)

Sodium caseinate was dissolve in water, heated to 53° C. and adjusted to pH 7.5 with NaOH. The caseinate was then hydrolysed with Trypsin and Alcalase between pH 7.0 and 7.5. As the viscosity decreased more sodium caseinate was added. The reaction was allowed to continue for 22 hours. After 22 hours HCl was added to reduce the pH to 4 to denature the enzymes. Once denatured the pH was raised back to 5 and the material was filtered to remove any undissolved material. The product was then purified with activated carbon before being evaporated to the desired concentration and preserved.

### Hydrolysed Silk Protein (MW 463 Da, Activity 12.4%) (P5)

Milled silk noils were stirred into a solution of NaOH and heated to between 55° C. and 85° C. The silk was allowed to hydrolyse for between 3 and 10 days before the pH of the slurry was dropped to pH 4 using HCl. All solids were removed via filtration and the resulting solution was purified with activated carbon. The product was then evaporated to the desired concentration and preserved.

### Hydrolysed Hemp Protein (MW 61,418 Da, Activity 10.26%) (P6)

Hemp protein isolate (100 g) was stirred tin water (400 g) and heated to 40° C. NaOH (25%, 65 g) was added. H₂O₂ (30%, 20 ml) was fed into the reaction at a rate of 1.16 ml/hr. After the reaction had been allowed to stir for 14 hours from the NaOH addition, HCl was added to reduce the pH to 7.5. The slurry was centrifuged and filtered to remove any solid material then dropped to pH 3.8 using HCl. The precipitate was washed by replacing the aqueous layer with clean water. Once the washing was complete the solid was redissolved by increasing the pH to 6.5 using NaOH. The final product was preserved to prevent microbial growth.

### Hydrolysed Potato Protein (MW 71,229 Da, Activity 11%) (P7)

Potato protein isolate powder was dispersed in water. To the slurry peracetic acid was added and the slurry was stirred for 24 hours. The peracetic acid was removed from the solution by repeat sediment washing with fresh water. The acid treated potato slurry was then raised to pH>12.5 using NaOH (25%). The slurry was then stirred for 24 hours before the pH was reduced to 9.0 and any undissolved material was removed. The soluble protein was then precipitated at pH 4 and sediment washed with fresh water. Once washed the precipitate was dissolved by raising the pH to 6 using NaOH (25%). The solution was then preserved to prevent microbial growth

### Leaf Penetration Examples

The following test method was used to assess leaf penetration properties of the prepared protein candidates P1 to P7.

Franz cells were set up containing:
Receptor solution: de-ionised water
Donor solution: 50 μL of a 2% solution of formulated pesticide diluted in de-ionised water. The formulated pesticide was prepared with a 10% headspace for penetrant inclusion (as per tables 1-5). Penetrants were added post formulation but pre-dilution.

The Franz cell experiments were used for diffusion experiments. Isolated cuticles from apple leaves were prepared based on the method detailed in US 2009/0247597.

Experiments were performed at a controlled temperature of 20° C. and a controlled relative humidity of 58%.

Experiments were performed for 72 hours to allow the pesticide uptake kinetics to reach an equilibrium in the receiver solution. After this time, 1 mL aliquots of the receiver solution were taken and analysed using HPLC.

HPLC-UV was used to assay pesticide concentration using an Agilent 1260 Quaternary LC system. Each penentrant was tested for leaf penetration properties with a total of 9 Franz cells used for percentage penetration determination. A calibration was carried out before each set of samples was analysed.

### Suspension Concentrate Formulations:

Suspension concentrate formulations comprising the penetrants were formed. The formulations prepared are shown in Tables 1 to 5 below.

TABLE 1
250 g/L Thifluzamide based concentrate (SC1)

| Phase | Component | Function | % w/w |
|---|---|---|---|
| Phase A | Thifluzamide Technical 96% | Fungicide | 25.00 |
| | Atlas G-5002L | Wetting agent | 2.00 |
| | Atlox 4913 | Dispersant | 3.00 |
| | Silcolapse 5001 | Antifoam | 0.5 |
| | Proxel GXL | Biocide | 0.2 |
| | Adjuvant headspace | | 10.00 |
| | Water | Aqueous phase | 48.3 |
| Phase B | Pricerine 9091 | Antifreeze | 4.8 |
| | Xanthan gum | Rheology modifier | 0.2 |

TABLE 2
250 g/L Azoxystrobin based concentrate (SC2)

| Phase | Component | Function | % w/w |
|---|---|---|---|
| Phase A | Azoxystrobin | Fungicide | 23.23 |
| | Atlas G-5002L | Wetting agent | 1.86 |
| | Atlox 4913 | Dispersant | 4.65 |
| | Silcolapse 5001 | Antifoam | 0.09 |
| | Proxel GXL | Biocide | 0.19 |
| | Adjuvant headspace | | 9.29 |
| | Water | Aqueous phase | 54.74 |
| Phase B | Pricerine 9091 | Antifreeze | 5.76 |
| | Xanthan gum | Rheology modifier | 0.19 |

TABLE 3
500 g/L Trifloxystrobin based concentrate (SC3)

| Phase | Component | Function | % w/w |
|---|---|---|---|
| Phase A | Trifloxystrobin | Fungicide | 44.46 |
| | Atlas G-5004LD | Wetting agent | 2.18 |
| | Atlox 4913 | Dispersant | 2.18 |
| | Silcolapse 5001 | Antifoam | 0.17 |
| | Proxel GXL | Biocide | 0.09 |
| | Adjuvant headspace | | 10.00 |
| | Water | Aqueous phase | 35.47 |
| Phase B | Pricerine 9091 | Antifreeze | 5.23 |
| | Xanthan gum | Rheology | 0.22 |
| | | modifier | |

TABLE 4
450 g/L Prothioconazole based concentrate (SC4)

| Phase | Component | Function | % w/w |
|---|---|---|---|
| Phase A | Prothioconazole | Fungicide | 44.46 |
| | Atlas G-5004LD | Wetting agent | 2.18 |
| | Atlox 4913 | Dispersant | 2.18 |
| | Silcolapse 5001 | Antifoam | 0.17 |
| | Proxel GXL | Biocide | 0.09 |
| | Adjuvant headspace | | 10.00 |
| | Water | Aqueous phase | 35.47 |
| Phase B | Pricerine 9091 | Antifreeze | 5.23 |
| | Xanthan gum | Rheology modifier | 0.22 |

TABLE 5
160 g/L Phenmedipham based concentrate (SC5)

| Phase | Component | Function | % w/w |
|---|---|---|---|
| Phase A | Phenmedipham | Herbicide | 16.22 |
| | Atlox 4913 | Polymeric dispersant | 0.8 |
| | Atlas G-5002L | Wetting Agent | 0.8 |
| | Silcolapse 5020 | Antifoam | 0.1 |
| | Proxel GXL | Biocide | 0.2 |
| | Water | Continuous phase | 65.52 |
| Phase B | Xanthan Gum | Rheology Modifier | 0.3 |
| | Pricerine 9091 | Antifreeze | 5.99 |
| | Headspace | Adjuvant | 10 |

### Uptake Results:

The formulations were then subjected to the leaf penetration tests note above to determine the effect of the hydrolysed protein. Mean values were taken from nine repetitions for penetration through apple leaf cuticles (T=20° C., RH=58%)

TABLE 6
Uptake results for all active, values
are % penetration after 72 hours

| Penetrant | SC2 | SC4 | SC3 | SC1 | SC5 |
|---|---|---|---|---|---|
| Active alone | 1.3 | 2.5 | 2.6 | 1.5 | 1.9 |
| P1 | 2.2 | — | — | 5.1 | 4.5 |
| P2 | 2.8 | — | — | — | — |
| P3 | 2.6 | — | — | — | — |
| P4 | — | 9.1 | — | 11.1 | — |
| P5 | 2.3 | — | 4.3 | — | 3.9 |
| P6 | 3.1 | 10.1 | 10.6 | — | 4.1 |
| P7 | 2.7 | — | — | — | — |

The penetration of all actives through apple leaf cuticles after 72 hours was enhanced by the penetrants as shown in Table 6. All penetrants were shown to significantly enhance the penetration of the active compared to the active alone after 72 hours.

It is to be understood that the invention is not to be limited to the details of the above embodiments, which are described by way of example only. Many variations are possible.

1. An agrochemical formulation comprising:
i) at least one penetrant; and
ii) at least one agrochemical active,
wherein the penetrant is a hydrolysed protein, the protein having molecular weight in the range between 200 to 150,000 Da.

2. The formulation according to claim 1, wherein the hydrolysed protein is derived from collagen, chickpea, hemp, elastin, keratin, casein or milk, whey, wheat, wheat starch, potato, soya, and/or silk protein.

3. The formulation according to claim 1, wherein the hydrolysed protein is derived from potato protein.

4. The formulation according to claim 3, wherein the hydrolysed potato protein has a weight average molecular weight (Mw) in the range from 400 Da to 110,000 Da.

5. The formulation according to claim 1, wherein the hydrolysed protein is derived from wheat protein.

6. The formulation according to claim 5, wherein the hydrolysed wheat protein has a molecular weight (weight average) in the range from 40 Da to 20,000 Da.

7. The formulation according to claim 1, wherein the hydrolysed protein is chemically unmodified hydrolysed protein.

8. A concentrate formulation suitable for making an agrochemical formulation in accordance with claim 1, the concentrate comprising:
i) at least one penetrant; and
ii) at least one agrochemical active,
wherein the penetrant is a hydrolysed protein, the protein having molecular weight in the range between 200 to 150,000 Da.

9. The concentrate formulation according to claim 8, wherein the formulation is an emulsifiable concentrate, emulsion concentrate, suspension concentrate, soluble liquid, as an oil-based suspension concentrate, and/or suspoemulsions.

10. The concentrate formulation according to claim 3, wherein the penetrant is present in the concentrate at from 1 wt. % to 20 wt. %.

11. Use of the hydrolysed protein in accordance with claim 1, as a penetrant in an agrochemical formulation comprising at least one agrochemical active.

12. A method of treating vegetation to control pests, the method comprising applying a formulation according to claim 1, either to the vegetation or to the immediate environment of the vegetation.

13. A method of treating vegetation to control pests, the method comprising applying a diluted concentrate formulation in accordance with claim 8, either to the vegetation or to the immediate environment of the vegetation.
